(19) United States
(12) Patent Application Publication
(10) Pub. No.: US 2024/0098022 A1
(43) Pub. Date: Mar. 21, 2024

(54) METHOD AND APPARATUS FOR PROVIDING MULTI VIRTUAL LOCAL AREA NETWORK SERVICE SUPPORTING DEVICE TO DEVICE COMMUNICATION

(71) Applicant: KT CORPORATION, Gyeonggi-do (KR)

(72) Inventors: Ho-Jun JANG, Gyeonggi-do (KR); Se-Hoon KIM, Gyeonggi-do (KR); Won-Chang CHO, Gyeonggi-do (KR); Sang-Hyun PARK, Gyeonggi-do (KR); Kun-Woo PARK, Gyeonggi-do (KR); Ji-Young JUNG, Gyeonggi-do (KR)

(73) Assignee: KT CORPORATION, Gyeonggi-do (KR)

(21) Appl. No.: 18/370,082

(22) Filed: Sep. 19, 2023

(30) Foreign Application Priority Data
Sep. 19, 2022 (KR) 10-2022-0118178

(51) Int. Cl. H04L 45/76; H04L 45/02

(52) U.S. Cl. CPC H04L 45/76; H04L 45/02

(57) ABSTRACT

Provided are a method and apparatus for providing a multi virtual local area network service to user equipments. The method may include storing VLAN routing information that includes user equipment information, which is information on user equipments subscribing to the multi VLAN service, and session information; receiving data from a first user equipment and extracting user equipment information and session information from the received data; determining whether the extracted user equipment information and session information is included in the VLAN routing information; determining the received data as a VLAN routing target if the extracted user equipment information and session information is included in the VLAN routing information; and transmitting the received data to a second user equipment corresponding to a destination of the received data based on the VLAN routing information

### BACKGROUND

The present disclosure relates to a method and apparatus for providing a multi virtual local area network (LAN) service supporting device to device (D2D) communication.

In typical wireless communication systems, communication between devices, excluding the D2D (Device to Device) method that does not go through the core network, has been carried out in a manner where the traffic is managed by the data network (DN) to which the device is connected.

Devices connected to the Internet network can communicate using a Public Internet Protocol (IP) address, while devices connected to a private network can communicate with each other using a private IP address. In other words, devices connected to the Internet network can communicate with each other through a path that goes via the access network—User Plane Function (UPF)—Internet network. Meanwhile, devices connected to the private network can communicate with each other through a path that goes via the access network—UPF—private network.

However, due to the limitations of IP resources, most devices connected to the internet network are under a network address translation (NAT) environment, which imposes constraints on device-to-device communication.

3rd generation partnership project (3GPP) has selected Time Sensitive Communication as one of the 5G Vertical Services and defined the standard for the 5G LAN-Type Service to support it.

The 5G LAN-Type Service defined in the standard introduces a method for device-to-device communication that doesn't go through the Data Network (DN). It presents core network local switching or traffic processing function between UPFs and offers a wireless network profile for possible device-to-device communication groups.

However, the 5G LAN-Type Service restricts the relationship between the Data Network (DN) and the device-to-device communication group (Virtual Network Group) to a 1:1 ration, resulting in an issue where devices using the internet network are classified into the same device communication group.

In typical corporate IT environments, companies set up an internal network. To communicate with IT equipment located within this internet network, one must either directly connect from within the internal network or, if direct access from the internal network is challenging from an external environment, they need to establish a Virtual Private Network (VPN) connection from the external network.

However, as corporate IT environments shift to the cloud, there is an increasing number of companies that do not set up their own internal networks. To handle critical information, they connect to virtual desktop infrastructure (VDI) located in the cloud and use it in conjunction with their internal networks.

While the cloud environment is suitable for general office tasks, it's not suitable for Internet of Things (IoT) communications involving machines, equipment, and sensor devices. For IoT communications, the cloud environment either uses a dedicated internal network or positions a central server in the internet environment, supporting only unidirectional communication.

In 5G mobile networks that support the LAN-Type Service, a LAN can be easily set up through device-to-device communication functions without going through the data network. However, since the majority of mobile devices utilize the Internet, there are challenges in constructing a mobile based dedicated LAN due to the limitation of being able to assign only one virtual group per DN.

### SUMMARY

In accordance with an aspect of the present embodiment, a method and apparatus may be provided for establishing (e.g., constructing) multiple virtual local area networks through device-to-device communication without establishing a data network or going through a data network (DN).

In accordance with another aspect of the preset embodiment, a system may be provided to provide a multi VLAN service that may enable user equipments to form at least one virtual local area network (VLAN) within a radio access network and a core network without establishing a private data network, without going through a data network, or without using a data network (e.g., physical data network) and communicate to each other through the virtual local area network in accordance with an embodiment.

In accordance with further another aspect, a multi VLAN service may be provided to i) arrange (classify, organize) a plurality of user equipments into a plurality of virtual groups (e.g., VLAN groups) according to a predetermined purpose and ii) enable each user equipment in a virtual group to operate as a LAN node, and iii) enable user equipment to communicate with other user equipment in the same virtual group without establishing a private data network, without going through a data network, or without using a data network (e.g., physical data network).

In accordance with still anther aspect, a system may collect subscription and registration information for the multi VLAN service from user equipment, determine whether user equipment is registered for multi VLAN service based on the collected information, route data to/from user equipment 200 through a corresponding virtual local area network if user equipment 200 is registered for multi VLAN service, and route data to/from user equipment 200 to a corresponding data network if user equipment 200 is not registered for multi VLAN service.

In accordance with one embodiment, a method of an apparatus may be provided for providing a multi virtual local area network (VLAN) service to user equipment (UE). The method may include: storing VLAN routing information that includes user equipment information, which is information on user equipments subscribing to the multi VLAN service, and session information; receiving data from a first user equipment and extracting user equipment information and session information from the received data; determining whether the extracted user equipment information and session information is included in the VLAN routing information; determining the received data as a VLAN routing target if the extracted user equipment information and session information is included in the VLAN routing information; and transmitting the received data to a second user equipment corresponding to a destination of the received data based on the VLAN routing information.

The VLAN routing information may include i) session identifiers of sessions connected to a plurality of user equipments subscribing to the multi VLAN service and ii) Internet Protocol (IP) addresses allocated to the plurality of user equipments, each mapped to the session identifiers. In this case, the transmitting operation may include: determining a session identifier matched with a destination IP address of the received data from the VLAN routing information; converting a session identifier of the received data to the determined session identifier; and transmitting the received data with the converted session identifier to a second user equipment corresponding to the destination IP address. The session identifier matched the destination IP address may be a session identifier of a session connected to the second user equipment.

The VLAN routing information may include session identifiers, IP address ranges, network identifiers, and VLAN group identifiers of user equipments subscribing to the multi VLAN service. In this case, the operation of determining the received data as a VLAN routing target may include i) determining whether a network identifier matched to a session identifier extracted from the received data is included in the VLAN routing information, ii) determining whether a destination IP address extracted from the received data is included in the VLAN routing information in an event that the network identifier is included in the VLAN routing information, iii) determining the received data as a VLAN routing target in an event that the destination IP address is included in the VLAN routing information.

The VLAN routing information may include the session identifier, the IP address range, and the network identifier, which are matched with a plurality of VLAN group identifiers. In this case, prior to the operation of determining the received data as a VLAN routing target, the method may include: determining whether a VLAN group identifier matched to an IP range including the destination IP address is identical to a VLAN group identifier matched to an IP range including a source IP address extracted from the received data. and the operation of determining may include determining the received data as a VLAN routing target in an event that the VLAN group identifiers are identical.

The method may further include discarding the received data the VLAN group identifiers are not identical after the determining.

After the operation of storing, the method may further include: delivering the received data to a data network in an event that the destination IP address determined from the received data is not registered at the VLAN routing information.

Prior the operation of storing, the method may further include: receiving a session establishment request for the plurality of user equipments from a session management function (SMF). In this case, the VLAN routing information may be obtained from the session establishment request.

After the operation of storing, the method may further include: receiving VLAN routing addition information from a session management function (SMF), wherein the VLAN routing addition information includes information on a secondary user equipment connected to a primary user equipment connected to a session; and mapping the VLAN routing addition information to a session identifier of the primary user equipment connected to the secondary user equipment and storing the mapped VLAN routing addition information. In this case, the secondary user equipment may be determined based on a session identifier matched to a destination IP address extracted from the received data, and the received data may be routed to the secondary user equipment by the first user equipment.

The VLAN routing information may include i) general packet radio service tunnelling protocol (GTP) ID as the session identifier, data network name (DNN) as a network identifier, a VLAN group identifier, a user equipment identifier of a user equipment connected to a session, a IP address range allocated to the user equipment connected to the session, and an IP address range allocated to the secondary user equipment which is a lower level user equipment of the user equipment connected to the session.

In accordance with another embodiment, a method of an authentication apparatus may be provided for providing a multi virtual local area network (VLAN) to user equipment. The method may include: receiving a VLAN service authentication request of a target user equipment for creating a session from a session management function (SMF); and transmitting a VLAN service authentication response including information on an Internet Protocol (IP) address allocated to the user equipment to the SMF, wherein the allocated IP address is transferred to a user plane function (UPF) by the SMF and used to perform VLAN communication between user equipments by the UPF.

The target user equipment may be a primary user equipment that is connected to a secondary user equipment and supports network access of the secondary user equipment. In this case, after the operation of transmitting, the method may include: receiving a VLAN service authentication request of the secondary user equipment from the primary user equipment; determining whether the secondary user equipment subscribes for the multi VLAN service based on secondary user equipment information identified from the VLAN service authentication request; allocating an IP address within an IP range matched to a VLAN group identifier determined based on an network identifier extracted from the VLAN service authentication request or the secondary user equipment information in an event that the secondary user equipment subscribes to the multi VLAN service; and transmitting a VLAN service authentication response including the allocated IP address to the primary user equipment.

After the operation of allocating, the method may further include: transmitting the IP address allocated to the secondary user equipment to the SMF. The IP address allocated to the secondary user equipment may be transmitted to the UPF from the SMF and used for the VLAN communication.

In accordance with further another embodiment, an apparatus connected to internal nodes of a core network and performing operations as a user plane function (UPF) may be provided for providing a multi virtual local area network (VLAN) to user equipment. The apparatus may include: a memory configured to store VLAN routing information including user equipment information and session information of user equipments subscribing the multi VLAN service; and at least one processor configured to create at least one VLAN router per each VLAN group for relaying communication between user equipments belonging to a same VLAN group through the created at least one VLAN router. The at least one VLAN router determines that the received data is a VLAN routing target in an event that user equipment information and session information extracted from a first user equipment is included in the VLAN routing information and transmitting the received data to a second user equipment which is a destination of the received data based on the VLAN routing information.

The VLAN routing information may include mapping information of session identifiers of sessions connected to a plurality of user equipments subscribing the VLAN service and IP addresses allocated to the plurality of user equipments. The at least one VLAN router may be configured to convert the session identifier of the received data to a session identifier matched to a destination IP address of the received data in order to transmit the received data to the second user equipment corresponding to the destination IP address.

The apparatus may further include a packet detection circuit configured to analyze the received data based on a packet detection rule (PDR) and relay the received data to the at least one VLAN router based on a forwarding detection rule based on the analysis result.

The VLAN routing information may include mapping information on session identifiers, IP address ranges, network identifiers, and VLAN group identifiers of user equipments subscribing the multi VLAN service. In this case, the packet detection circuit may be configured to: extract a session identifier, a destination IP address, and a source IP address from the received data according to the packet detection rule, determine a network identifier matched to the session identifier from the VLAN routing information, and relay the received data to a VLAN router corresponding to the VLAN group identifier according to the forwarding detection rule.

The packet detection circuit may be configured to: determine whether a VLAN group identifier matched to the source IP address of the received data is identical to a VLAN group identifier matched to the destination IP address of the received data based on the VLAN routing information; deliver the received data to the VLAN router in an event that the VLAN group identifiers are identical; and discard the received data in an event that the VLAN group identifiers are not identical.

The apparatus may further include a tunneling interface configured to be connected to tunneling sessions of the plurality of user equipments and to be connected to the at least one router.

The apparatus may further include a data network router configured to route the received data to a corresponding data network. In this case, the packet detection circuit may be configured to transmit the received data to the data network router in an event that the determined session identifier or the destination IP address is not registered at the VLAN routing information.

The IP address range may include a primary user equipment IP address range of IP addresses allocated to a primary user equipment directly connected to the sessions, a secondary user equipment IP address range of IP addresses allocated to at least one secondary user equipment connected to the session through the primary user equipment. The VLAN routing information may include mapping information of the first user equipment IP address range and the secondary user equipment IP address range. In this case, the at least one VLAN router may be configured to: determine the first user equipment IP address range from the VLAN routing information using the destination IP address; convert a session identifier of the determined first user equipment IP address range with a session identifier of the received data, and delver the received data to a primary user equipment connected to a secondary user equipment corresponding to the destination IP address.

### BRIEF DESCRIPTION OF THE DRAWINGS

FIG. 1 is a diagram illustrating a system for providing a multi virtual local area network (VLAN) service in accordance with an embodiment.

FIG. 2 is a block diagram illustrating user plane function (UPF) for providing a VLAN service in accordance with an embodiment.

FIG. 3 is a diagram for explaining a plurality of VLAN groups in accordance with one embodiment.

FIG. 4 is a flowchart illustrating a method of provisioning VLAN routing information in accordance with an embodiment.

FIG. 5 is a flowchart illustrating a method of establishing a session for setting up VLAN routing information in accordance with an embodiment.

FIG. 6 is a flowchart illustrating a method for providing a VLAN service to user equipment in accordance with an embodiment.

FIG. 7 is a diagram illustrating a VLAN service system in accordance with another embodiment.

FIG. 8 is a flowchart illustrating a method for registering VLAN routing information of secondary user equipment connected to primary user equipment in accordance with an embodiment.

FIG. 9 is a flowchart illustrating a VLAN service procedure in accordance with another embodiment.

### DETAILED DESCRIPTION OF EMBODIMENTS

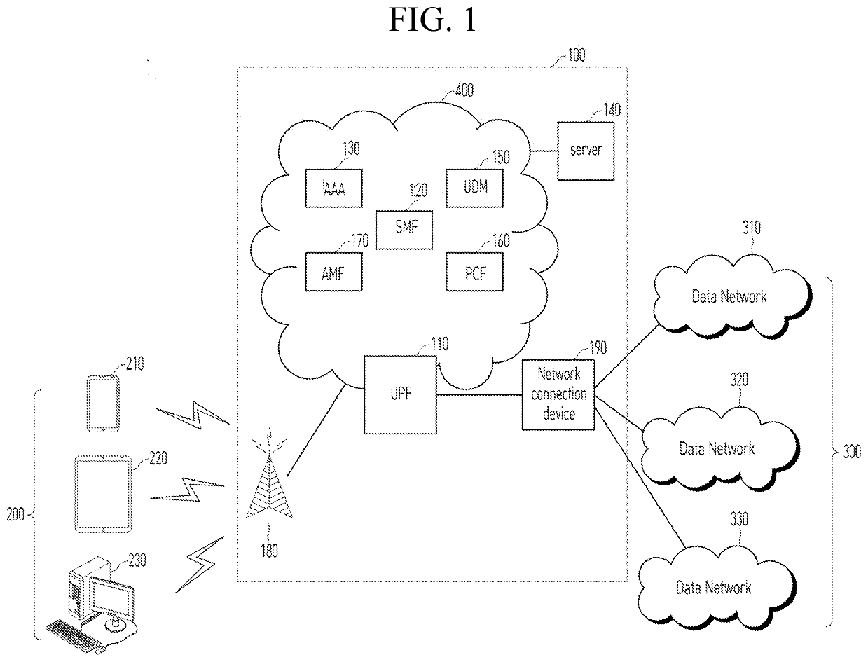

Hereinafter, a method and apparatus for providing a multi VLAN service in accordance with an embodiment will be described with reference to the accompanying drawings. First, a system for providing a multi VLAN service will be described with reference to FIG. 1. Here, the 5G network system is used as an example to describe embodiments. However, the embodiments are not limited to 5G networks. For example, embodiments may be applied to other communication networks as well, such as 3G network system or Long Term Evolution (LTE) network system.

FIG. 1 is a diagram illustrating a system for providing a multi VLAN service in accordance with an embodiment. Referring to FIG. 1, system 100 may provide a multi VLAN service in accordance with an embodiment. The multi VLAN service may enable user equipments to form a virtual local area network (VLAN) within a radio access network and a core network without establishing a private data network, without going through a data network, or without using a data network (e.g., physical data network) and communicate to each other through the virtual local area network in accordance with an embodiment. Further, the multi VLAN service may enable user equipments to multiple virtual location area networks within a radio access network and a core network in accordance with an embodiment.

In particular, the multi VLAN service may i) arrange (classify, organize) a plurality of user equipments into a plurality of virtual groups (e.g., VLAN groups) according to a predetermined purpose and ii) enable each user equipment in a virtual group to operate as a LAN node, and iii) enable user equipment to communicate with other user equipment in the same virtual group without establishing a private data network, without going through a data network, or without using a data network (e.g., physical data network) in accordance with an embodiment.

That is, system 100 may provide a multi VLAN service to user equipment 200. For example, i) system 100 may collect subscription and registration information for the multi VLAN service from user equipment 200, ii) system 100 may determine whether user equipment 200 is registered for multi VLAN service based on the collected information, ii) system 100 may route data to/from user equipment 200 through a corresponding virtual local area network if user equipment 200 is registered for multi VLAN service, iv) system 100 may route data to/from user equipment 200 to a corresponding data network if user equipment 200 is not registered for multi VLAN service.

Such system 100 may include radio access network 180, core network 400, service server 140, and network connection device 190 in accordance with an embodiment. Such system 100 may be connected to a plurality of user equipments 200 and connected to a plurality of data networks 300 in accordance with an embodiment.

In accordance with an embodiment, user equipment 200 may receive a multi VLAN service to form multiple virtual local area networks without establishing a data network or without going through a data network and to communicate with other user equipment 200 in the same virtual group through the viral local area network.

User equipment 200 may be any device including at least one processor, memory, input/output circuit, and communication circuit and be installed with a predetermined operating system and applications (e.g. apps) to enable a user to communicate with other devices. For example, user equipment 200 may be a smart phone 210, a mobile device, a tablet 220, a personal computer (PC) 230, a laptop computer 240, and various Internet of Things (IoT) devices (e.g., smart watch 211). However, the embodiments are not limited thereto. User equipment 200 may be any device connected to a wireless network and capable of data communication. User equipment 200 may be any device capable of data communication with being connected to a wireless network.

In accordance with an embodiment, a multi VLAN service app may be installed in user equipment 200 in order to use a multi VLAN service. Hereinafter, a part or entire operation of user equipment 200 may be performed by the multi VLAN service app.

In accordance with an embodiment, user equipment directly connected to 5G communication network (e.g., system 100) may be referred to as primary user equipment or upper-level user equipment. For example, UE 210, 220, 230 shown in FIG. 1 may be primary user equipment.

User equipment connected to a 5G communication network through the primary device may be referred to as secondary user equipment or lower-level user equipment. For example, UE 211 may be secondary user equipment. The term secondary user equipment is not limited to user equipment directly connected to the primary user equipment; it may also refer to devices at any subsequent tier, such as a ‘n’th level user equipment.

The primary user equipment may be a user equipment directly connected to a communication session established to a communication network (e.g., radio access network and core network). The secondary user equipment may be a user equipment not directly connected to the communication session. The secondary user equipment may be a user equipment connected to the communication session through the primary user equipment.

The primary user equipment may be a mobile router like a wireless egg, or any mobile device (e.g., smart phone, tablet) equipped with mobile routing capabilities. The secondary user equipment may include devices like laptops or Internet of Things (IoT) devices. Primary and secondary devices may be connected in various pre-agreed manners, such as via WiFi, universal serial bus (USB), or unshielded twisted pair (UTP).

Such user equipment 200 may subscribe the multi VLAN service, register itself for the multi VLAN service through system 100, and receive the multi VLAN service from system 100 in accordance with an embodiment.

In particular, user equipment 200 may access service server 400, subscriber the multi VLAN service and register itself for the multi VLAN service through service server 400 in accordance with an embodiment.

Service server 140 may be a computer system of a service provider company that offers a multi VLAN service to enable user equipments for forming multiple virtual local area networks without establishing or going through data network and communicating each other through the virtual local area networks. In order to provide the multi VLAN service, service server 140 may provide an application, a program, an app, and a website that allow users to register or subscribe for the multi VLAN service in accordance with an embodiment.

For example, a user may download an application, app, or software program on his/her devices, such as UE 200, install the downloaded app, and execute the installed app. Such an executed app may provide a user interface (UI) for registering and subscribing to the multi VLAN service. As another example, a user may access a designated website operated by service server 140 and register or subscribe to the multi VLAN service through the designated website. As further another example, user equipments such as secondary user equipment may be manufactured or produced to include a hardware function or a software function to receive the bidirectional communication service.

Through the user interface provided by the executed application or the website, a user or a subscriber is allowed to register at least one of user equipment 200 to have the multi VLAN service. That is, the registered user equipment may be enabled to form virtual local area networks and communicate with other user equipment in the same virtual LAN group in accordance with an embodiment.

In accordance with an embodiment, service server 140 may provide subscription and management information to core network 400 including SCF 120 to enable SCF 120 to build policies based on the subscription and management information. Service server 400 may deliver subscription information and VLAN service information to core network 100, such as UDM 150 and SCF 120.

For example, anyone including businesses/operators who wish to utilize user equipment to have the multi VLAN service may perform a subscription and registration procedure on service server 140, as described above. During the subscription and registration procedure, service server 140 may collect necessary information, such as subscription and registration information, on user equipment 200 for providing the multi VLAN service.

For example, service server 140 may i) collect information from user equipment 200, such as IMSI and GPSI, ii) create and assign a Virtual Group ID to user equipment 200, and iii) assign a VLAN IP range to user equipment 200 in accordance with an embodiment.

The subscription and registration information may include i) detailed information on user equipment to participate in a virtual local area network and ii) a VLAN IP range to be assigned to the user equipment. Here, the VLAN IP range is referred to as a set of consecutive IP addresses to be assigned to user equipments participating in the same virtual local area network.

Based on the subscription and registration information, service server 140 may generate i) subscription information as shown in Table 2 below and ii) VLAN service information as depicted in Table 3 below. Table 2 is an example of managing subscription information for 5G mobile communications.

TABLE 2

| | GPSI | Virtual Group ID | |
|---|---|---|---|
| IMSI | (IMSISDN) | (External& Internal) | UE IP |
| Key | Service membership | Virtual group service Key | xxxx |

As shown in Table 2, the subscription information may include an internal mobile subscriber identity (IMSI) of user equipment, a generic public subscription identifier (GPSI) of user equipment, a virtual group identifier (ID) assigned to user equipment, and a VLAN IP range assigned to user equipment (UE IP).

Table 3 below is an example of VLAN service information.

TABLE 3

| VLAN | | VLAN group data | | |
|---|---|---|---|---|
| group ID | UE ID | DNN, S-NSSAI | GW IP | IP range |

| | | | |
|---|---|---|---|
| Key | Subscriber | Target NW | Occupied IP |

As shown in Table 3, the VLAN service information may include information on a VLAN group ID, a UE ID, and VLAN group data. The VLAN group ID is an identifier of a VLAN group that user equipment belongs to (VLAN group ID). The UE ID is an identifier of user equipment such as IMSI, GPSI, or MSISDN. MSISDN stands for mobile station international subscriber directory number, which is a unique identifier assigned to each mobile device on a global system for mobile communication (GSM) network. The VLAN group data may include i) a network identifier such as, data network name (DNN)/single-network slice selection assistance information (S-NSSAI)), ii) an IP address of network connection device 190 (e.g., Gateway (GW) IP address), and iii) an IP range which is a VLAN IP address assigned to user equipment 200.

In this specification, a data network name (DNN) and a single-network slice selection assistance information (S-NSSAI) may be used as identification for identifying each data network. A VLAN group ID may be used as identification for identifying each VLAN group.

DNN or S-NSSAI and VLN group ID may be mapped to a 1 to N manner. That is, one DNN or one S-NSSAI may be mapped to multiple (N) VLAN groups. One data network identified by one DNN or one S-NSSAI may be mapped to multiple (N) VLAN groups in accordance with an embodiment.

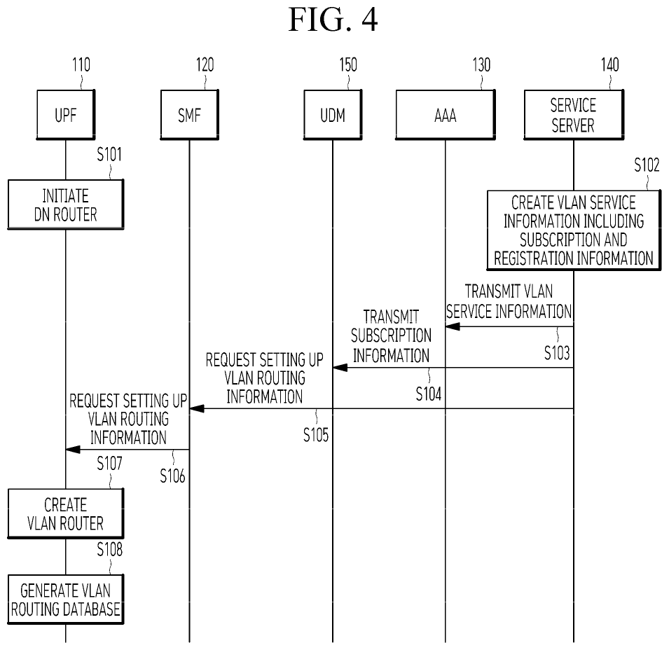

Service server 140 may distribute the subscription and registration information to internal nodes of 5G core network, for example, session management function (SFM) 120, authentication, authorization, and accounting (AAA) 130, and unified data management (UDM) 150. Further, Service server 140 may distribute the subscription information shown in Table 2 to UDM 150 and distribute the VLAN service information shown in Table 3 to AAA 130. AAA 130 may be referred to as an authentication device or an authentication server. Such AAA 130 may be implemented as an independent computing system connected to internal nodes of core network 400. That is, service server 140 may deliver VLAN service information (e.g., network ID (DNN), user equipment IP (IMSI/GPSI)) in Table 2 and Table 3, to user plane function (UPF) 110 through SMF 120 in accordance with an embodiment. The process of distributing the subscription and registration information to internal nodes of core network will be detailed later with reference to FIG. 4.

Service server 140 may collect information on user equipment and provide it to system 100 using existing infrastructure of 5G network with minimum modification of messages defined by 5G standard specification in accordance with an embodiment.

As described, core network 400 may receive the subscription and registration information from service server 140 and route data from user equipment 200 to one of corresponding virtual local area network or data network based on the subscription and registration information in accordance with an embodiment. Hereinafter, core network 400 will be described in more detail.

Core network 400 may include multiple network functions. Each number functions may be implemented as an independent computing server or a group of computer systems, which are connected to each other through a predetermined communication link. Further, the multiple network functions may be implemented in a cloud computing system.

In accordance with an embodiment, core network 400 may include User Plane Function (UPF) 110, Session management function (SMF) 120 which creates packet data unit (PDU) sessions and connects to the data network (DN) to process traffic through the user plane function (UPF) 110, the policy control function (PCF) 160 which controls billing and serviced quality policies, Access and Mobility Management Function (AMF) 170, and Unified Data Management (UDM) 150 which manages subscription information. Core network 400 may further include Unified data repository (UDR) and network exposure function (NEF).

To provide the multi VLAN service to user equipments, the network functions of core network 400 may perform the following operations in accordance with an embodiment.

User Plane Function (UPF) 110 will be described as one of internal function nodes of core network 400 for convenience to description and ease of understanding. However, the embodiments are not limited thereto. For example, UPF 110 may be implemented as an independent computing system performing the following operations and connected to other internal function nodes of core network in accordance with another embodiment.

UPF 110 may be an internal function node of a core network, which performs data forwarding, session management, packet routing and forwarding, and QoS handing. Further, UPF 110 may operate as an interface with other network functions, such as Access and Mobility Management (AMF) and Session Management Function (SMF) and as the gateway for user traffic to and from external networks (e.g., data network).

In accordance with an embodiment, UPF 110 may receive a service request from user equipment 200 and provide one of a multi VLAN service and a DN service to user equipment based on the service request in accordance with an embodiment. Here, the DN service is to route data from/to user equipment 200 to a corresponding data network.

UPF 110 may establish sessions with a plurality of user equipments 200, mediate communication between user equipments 200 and data networks 301, 302, 303, and mediate VLAN communication among user equipments 200 through the established sessions.

In accordance with an embodiment, UPF 110 may set up and update VLAN routing information based on a VLAN group ID. When at least two user equipments participating the multi VLAN service connect to core network 400, UPF 110 finalizes the VLAN routing information. For user equipment participating after finalizing the VLAN routing information, UPF 110 updates the VLAN routing information with GTP ID of the new user equipments.

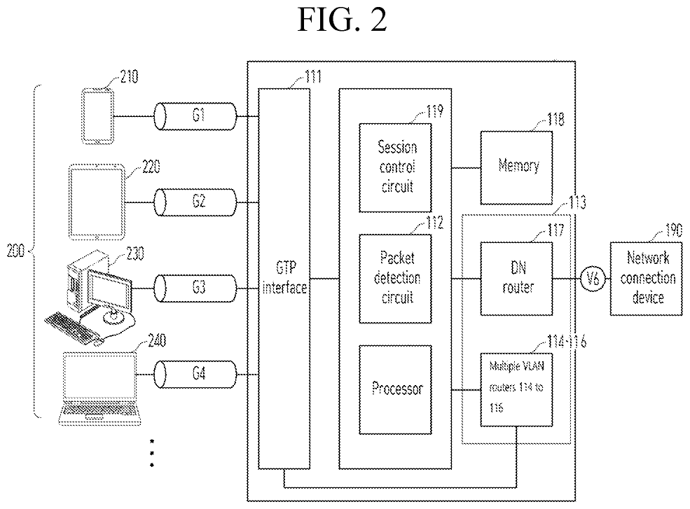

UPF 110 may be connected to network connection device 190 (e.g., gateway (GW)) via an N6 interface, for example, through a physical wire. Although there is only one physical line, UPF 110 may configure multiple virtual routers (as shown in FIG. 2 117) to branch out to multiple data networks 301, 302, 303 corresponding to DNN/S-NSSAI.

UPF 110 may establish a multi VLAN service environment based on Device-to-Device (D2D) communication by reflecting VLAN routing information in a PDR (Packet detection rule) and Forwarding Date rule (FDR) (e.g., forwarding detection rule) in accordance with an embodiment. For example, UPF 110 sets up PDR/FDR information to deliver data to the data networks 301, 302, 303 or to VLAN group.

The Packet detection rule (PDR) is a rule defined for UPF 110 to extract a general packet radio service tunneling protocol (GTP) ID, a source IP address, and a destination IP address from a received data, and analyze data based on the extracted information. The Forwarding detection rule (FDR) is a rule defined to forward data based on the analysis result.

UPF 110 may initially set up VLAN routing information to provide a multi VLAN service of a predetermined VLAN IP range (e.g., 10.10.10.1/32 range). UPF 110 may generate a sub-filter rule for branching a VLAN service in PDR/FDR when user equipment 200 participates in system 100 for the first time and map the routing source to the GTP ID of user equipment 200. When the VLAN routing information is completed, one of the DN service and the multi VLAN service may be provided. As described, the DN service may be routing data to a data network, and the multi VLAN service may be routing data to a virtual local area network.

When another user equipment 200 accesses system 100 for the multi VLAN service, UPF 110 may update destination information of another user equipment 200, such as GTP ID, to the PDR/FDR and the sub-filter rule.

UPF 110 may complete the VLAN routing information if more than two user equipments 200 access the system for the multi VLAN service.

In accordance with an embodiment, UPF 110 may use a VLAN IP range as a reference to route data. That is, if a destination IP range of data is included within the VLAN IP range, a user equipment within the same VLAN group becomes the destination of the data. If the destination IP range of data is not included within the VLAN IP range, the destination of data is one of data networks. 301, 302, 303.

UPF 110 may generate VLAN routing information (e.g., VLAN routing database) based on information received from SMF 120, as shown in table 1 below.

TABLE 1

| VLAN | | | VLAN group data | | |
|---|---|---|---|---|---|
| group ID | UE ID | GTP ID | DNN/S-NSSAI | GW IP | IP range |
| Key #1 | UE #1 | ID #1 | DNN #1 | Xxxx | Xxxxx/20 |
| Key #1 | UE #2 | ID #2 | DNN #1 | xxxx | Xxxxx/20 |

UPF 110 may generate the VLAN routing information shown in Table 1 based on information received from SMF 120 (e.g., VLAN group ID (Key #1), User equipment ID (UE #1), and VLAN group data) during establishing a session of first user equipment #1 200. Then, when a GTP tunnel session to first user equipment 200 is established, the GTP ID (e.g., ID #1) is reflected to the VLAN routing information.

Then, UPF 110, during a session of second user equipment #2 200 is establishing, generates a VLAN routing database as shown in Table 1 based on the information from SMF 120 (e.g., VLAN group ID (Key #1), UE ID (UE #2), and VLAN group data). When GTP tunnelling session to second user equipment 200 is established, GTP ID (e.g., ID #2) is reflected to the VLAN routing database.

In Table 1, the VLAN group ID is an identifier of a VLAN group where user equipment 200 belongs to. UE ID is an identifier of user equipment 200. UE ID may be one of IMSI and GPSI (MSISDN), where IMSI stands for international mobile subscriber identify, GPSI stands for generic public subscription identifier, and MSISDN stands for mobile station international subscriber directory number. GTP ID is an identifier (ID) of a GTP tunneling session connected to user equipment 200.

VLAN group data may include DNN/S-NSSAI, GW IP, and IP range. DNN/S-NSSAI indicates a data network (301, 302, 303) available to user equipment 200. GW IP may be an IP address of network connection device 190 (e.g., gateway) connected to data networks 301, 302, 303 that user equipment 200 may use. IP range may be a VLAN IP address range allocated to user equipment 200.

Since the multi VLAN service is provided based on device-to-device communication, routing information is not completed before more than two participating user equipment 200 accesses core network 400. That is, UPF 110 completes the VLAN routing database when the VLAN routing information of first and second user equipments 200 are registered. Completion means that it is finalized in a form where VLAN service is possible, and thereafter, VLAN routing information for multiple user equipments 200 may also be added.

UPF 110 may establish, add, delete, or modify a VLAN group based on requests from AAA 130 or service server 140 through SMF 120. Here, the modification of the VLAN group refers to the addition/deletion of user equipment 200 belonging to the VLAN group.

Based on the VLAN routing information, UPF 110 may route data received from user equipment 200 to a data network identified by DNN 301, 302, 303, or to another user equipment 200 within the same VLAN group. In other words, user equipments 200 belonging to the same VLAN group may engage in D2D (device to device) communication due to UPF 110's VLAN routing function, in accordance with an embodiment.

Session Management Function (SMF) 120 may be one of the internal function nodes of core network, which processes a control plane of traffic. For example, SMF 121 may establish, create, modify, and release a session between user equipment and a data network. Further, SMF 120 may determine and manage a routing and forwarding path of user data. In accordance with an embodiment, SMF 120 may retrieve (e.g., search) subscription information for configuring a virtual local area network and establishing a PDU sessions.

In accordance with an embodiment, functions of SMF 120 may be used to provide the multi VLAN service by changing pre-defined messages for subscription information, session authentication, and user plane control without changing or modifying PDU session establishment/modification procedure that all core nodes participate.

For example, SMF 120 may confirm whether user equipment 200 subscribes to the multi VLAN service through inquiry to UDM 150 when user equipment 200 requests VLAN PDU session establishment.

When SMF 120 determines that user equipment 200 subscribes to the VLAN service, SMF 120 askes AAA 130 to perform a VLAN service authentication on user equipment 200. After completion of VLAN service authentication, SMF 120 may collect VLAN routing information.

SMF 120 may perform provisioning (e.g., setting up and managing resources, configurations, and services) upon generation of a multi VLAN service at service server 140. That is, SMF 120 may set up basic information for VLAN data routing (e.g., VLAN routing information) for UPF 110. Such provisioning operation will be detailed later with reference to FIG. 4.

SMF 120 provides VLAN routing information to UPF 110, and UPF 110 reflects the VLAN routing information to PDR and FDR.

AAA 130 may receive information (e.g., VLAN service information) necessary for VLAN service authentication from service server 140 and perform provisioning.

AAA 130 may be located within core network 400 and provides the necessary information on user equipment 200 to operate as a VLAN node. Specifically, AAA 130 may perform VLAN service authentication for user equipment 200, designate the VLAN IP range, and assign IP addresses in accordance with an embodiment. Service server 140 may manage information for providing a multi VLAN service to user equipment 200 and offers services for the authentication and traffic routing of user equipment to the 5G core node.

The multi VLAN service is an additional service to the DN service. Therefore, the multi VLAN service may be referred to as the VLAN supplementary service.

UDM 150 may store the subscription information of user equipment 200 participating a virtual local area network. Based on the subscription information, the enrollment status of the VLAN service for the user equipment 200 is determined when a session for user equipment 200 is created.

PCF 160 may collaborate with SMF 120 to establish or modify SM policy rule. AMF 170 may receive network access requests from user equipment 200 and respond to them.

In addition, system 100 may further include radio access network 180 and network connection device 190 in accordance with an embodiment. Radio access network 180 may be referred to as a base station. Radio access network 180 may be wirelessly connected to user equipments 200. Network connection device 190 may serve as a switch and/or router and may be connected to multiple data networks 301, 302, 303. Data network may be referred to as DN. Multiple data networks 301, 302, 303 may be distinguished or identified as a data network name (DNN).

Radio access network (e.g., base station) 180 establishes a data bearer connection with user equipment 200 and creates a GTP tunnelling session to connect with UPF 110 for user equipment 200. Network connection device 190 is connected to UPF 110 and a plurality of data networks 301, 302, 303 through N6 interface. Network connection device 190 may be a switch or a router as a gateway for accessing data network 301, 302, 303.

In this specification, the data network may include the public network and the dedicated network (e.g., private network). The public network refers to networks like the Internet, which provide mobile communication services to the general public. The dedicated network refers to private networks or intranets, which are access-restricted and serve specific subscribers.

Hereinafter, UPF 110 will be detailed with reference to FIG. 2. As described above, UPF 110 is described as an internal function node of a core network. However, the embodiments are not limited thereto. For example, UPF 110 may be implemented as an independent computer server that is connected to internal nodes of the core network and that performs the operations for providing a multi VLAN service in accordance with an embodiment as well as generation functions of UPF, such as data forwarding, session management, packet routing and forwarding, QoS handing, an interface with other network functions, and the gateway for user traffic to and from external networks (e.g., data network).

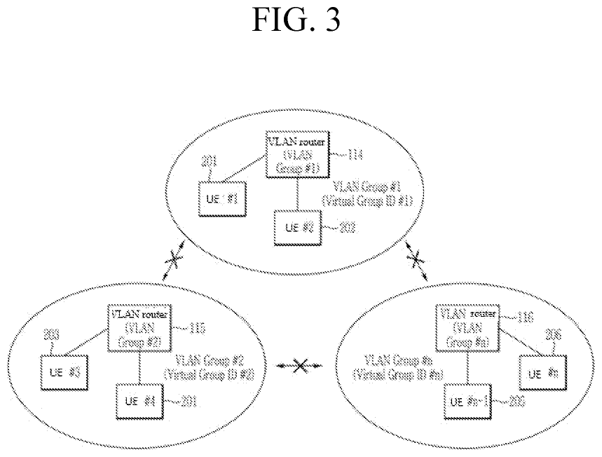

FIG. 2 is a diagram illustrating a UPF in accordance with an embodiment. FIG. 3 is diagram for explaining a plurality of VLAN groups in accordance with an embodiment.

Referring to FIG. 2, UPF 110 may be a computing system having at least one processor, a memory, a communication circuit (e.g., input/output circuit). In accordance with an embodiment, UPF 110 may include GTP Interface 111 (e.g., input circuit), processing circuit 115 including session control circuit 119, packet detection circuit 112, and processor 113, memory 118, data network (DN) router 117, and virtual router 114.

Memory 118 may store a variety of information, such as software programs for operation, data received from other entities, and data generated as result of operations. That is, memory 118 may store an operation system, applications, and related data, received from other entities through a variety of communication media (e.g., communication networks). Memory 118 may include at least one of an internal memory and an external memory according to embodiments. For example, memory 118 may be a flash memory, hard disk, multimedia card micro memory, SD or XD memory, Random Access Memory (RAM), Static Random-Access Memory (SRAM), Read-Only Memory (ROM), Programmable Read-Only Memory (PROM), Electrically Erasable Programmable Read-Only Memory (EEPROM), magnetic memory, magnetic disk, or optical disk, a SD card, a USB memory, but is not limited thereto.

Memory 118 may include instructions for controlling GTP interface 111, VLAN routing information, multi VLAN app, for performing the operations for providing a multi VLAN service in accordance with an embodiment.

Processing circuit 115 may include packet detection circuit 112, session control circuit 119, and processor 113. Processing circuit 115 may perform or control overall operation of UPF 110. For example, processor 113 may be a central processing circuitry that controls constituent elements (e.g., memory, communication circuit, display, input/output circuit, etc.) of UPF 110 and/or performs a variety of operations (or functions) of UPF 110 for providing a multi VLAN service. In accordance with an embodiment, processing circuit 115 including packet detection circuit 112 and session control circuit 119 may perform various operations for providing a multi VLAN service.

GTP interface 111 may be connected to a plurality of user equipments 201 to 204 through a plurality of tunneling sessions G1 to Gn, respectfully, and a plurality of VLAN routers 114, 115, and 116. GTP interface 111 may output data received through each tunneling session to packet detection circuit 112. GTP interface 111 may output data to tunnelling sessions matched with GTP IP.

Packet detection circuit 112 may analyze data based on a packet detection rule (PDR), forward data based on analysis result according to a forwarding detection rule (FDR). That is, packet detection circuit 112 may extract DNN, GTP ID, destination IP address, and source IP address based on the packet detection rule (PDR). Packet detection circuit 112 may identify a VLAN group ID based on GTP ID and destination IP address if DNN, GTP ID, and destination IP address are registered at VLAN routing information. Packet detecting unit 112 forwards data to VLAN routers 114, 115, 116 corresponding to the identified VLAN group ID based on FDR.

In accordance with an embodiment, UPF 110 may create a plurality of virtual routers 113 each matched with a data network (e.g., per data network name (DNN)). One virtual router 113 may include a plurality of VLAN routers 114, 115, 116 and DN router 117 in accordance with an embodiment.

UPF 110 may generate a plurality of virtual routers 113 to match each data network based on the VLAN routing information received through SMF 112 and create a plurality of VLAN routers 114, 115, 116 and DN router 117 within virtual router 113 in accordance with an embodiment. Further, UPF 110 may create multiple VLAN routers 114, 115, 116 to match each VLAN group unit according to a VLAN routing information setup request received from service server 140 through SMF 120.

VLAN routers 114, 115, 116 may relay device-to-device (D2D) communication between user equipments 201 to 206. VLAN routers 114, 115, 116 may convert a GTP ID of data to another GTP ID matched to a destination IP range and transmit the data with the converted GTP ID to user equipment 200 corresponding to the converted GTP ID. VLAN routers 114, 115, 116 may operate according to VLAN routing information that is matched with a plurality of VLAN IDs and matching information of a plurality of GTP IDs to be processed as the same VLAN group and a plurality of VLAN IP ranges.

As described, FIG. 3 illustrates a plurality of VLAN groups in accordance with an embodiment. Referring to FIG. 3, VLAN router 114 may operate for a VLAN Group #1, which includes user equipment #1 201 and user equipment #2 202, and maps to Virtual Group ID #1. VLAN router 115 may operate for a VLAN Group #2, which includes user equipment #3 203 and user equipment #4 204, and maps to Virtual Group ID #2. VLAN router 116 may operate for a VLAN Group #3, which includes user equipment #5 205 and user equipment #6 206, and maps to Virtual Group ID #3.

For this purpose, VLAN routers 114, 115, 116 may deliver data to tunneling session corresponding to a destination IP address when both the VLAN group ID identified by the source IP address of the data and the VLAN group ID identified by the destination IP address are the same and match their own mapped VLAN group ID.

For example, data sent by user equipment #1 201 through the G1 session is delivered to user equipment #2 202 through the G2 session by VLAN router 114. Similarly, data sent by user equipment #2 202 through the G2 session is delivered to user equipment #1 201 through the G1 session by the VLAN router 114.

Furthermore, if the destination IP range of the data sent by user equipment #1 201 through the G1 session is not within the VLAN IP range, the data is delivered to the network connection device 190 and data network 301 by the DN router 117. In this manner, UPF 110 is capable of implementing both DN services and VLAN D2D services.

DN router 117 may identify a data network name (DNN) from the data and delivers the data to the network connecting device 190 that matches the identified DNN. Also, DN router 117 delivers the data received from the network connecting device 190 to the relevant user equipment 200 via the GTP interface.

As described, UPF 110 may i) receive the subscription information and the VLAN service information from service server 140 through internal nodes of core network 400, ii) create virtual routers based on the received information, and iii) create and update VLAN routing information based on the received information in accordance with an embodiment. Hereinafter, such provisioning operation will be described in more detail with reference to FIG. 4. FIG. 4 is a flowchart illustrating a method of provisioning VLAN routing information in accordance with an embodiment.

Referring to FIG. 4, UPF 110 may create and manage at least one DN router (e.g., 117 of FIG. 1) corresponding to each data network at step S101. The created DN router is a virtual router. Such a DN router may be connected to network connection device 190 through N6 interface and relay data communication between corresponding user equipments and corresponding data network.

In accordance with an embodiment, UPF 110 may create multiple data network (DN) routers to match each data network name (DNN) based on information previously configured. For example, multiple DN routers 117 may be connected to network connection device 190 and connected to a plurality of data networks (e.g., 301 to 303 of FIG. 1) which are identified by DNN through network connection device 190.

Meanwhile, service server 140 may generate subscription and registration information including i) subscription information and ii) VLAN service information according to a multi VLAN service agreements at step S102.

Service server 140 may transmit the VLAN service information to AAA 130 (e.g., authentication server or authentication device) at step S130, and service server 140 may transmit the subscription information to UDM 150 at step S140.

Service server 140 may request SMF 120 to configure (e.g., setup) VLAN routing information at step S150. The VLAN routing information may include i) at least one DNN, ii) at least one VLAN group ID belonging to the at least one DNN, and iii) at least one user equipment ID (e.g., IMSI, GPSI) belonging to the at least one VLAN group ID.

SMF 120 may transmit the request for configuring the VLAN routing information to UPF 110 at step S106.

UPF 110 may create at least one virtual local area network (VLAN) router to match each VLAN group ID at step S107.

UPF 110 may configure VLAN routing information and store the configured VLAN routing information in memory 118 at step S108. The VLAN routing information may include information on a data network name (DNN), user equipment ID, VLAN group ID, which are mapped together.

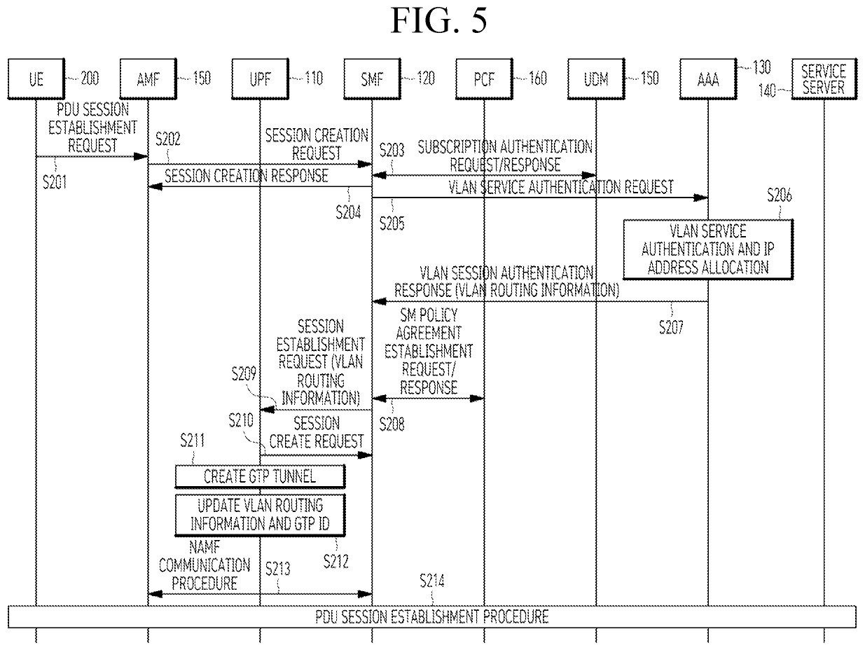

FIG. 5 is a flowchart illustrating a method of establishing a session for setting up VLAN routing information in accordance with an embodiment.

Such a method may be referred to as a session establishment procedure. It may be a PDU session Establishment procedure defined in 3GPP TS 23.520. At this time, the explanation is primarily focused on configurations related to the embodiment of the present disclosure, and for steps not depicted in the drawings, the 3GPP stands documents are referenced.

Referring to FIG. 5, AMF 170 receives PDU session establishment request from user equipment 200 at step S201, selects SMF 120, and transmit a session create request (Nsmf PDU Session Create SMContext Request) to the second SMF 120 at step S202.

At step S203, SMF 120 may perform authentication procedure with UDM 150. That is, SMF 120 may transmit a subscription confirmation request to UDM 150 and receive a subscription confirmation response from UDM 150 as the confirmation result.

For example, UDM 150 may receive the subscription information from service server 140 and determine that user equipment 200 is registered for a VLAN service if the subscription information includes a VLAN group ID matched with user equipment ID. Then, UDM 150 may transmit a subscription confirmation response including a VLAN service authentication request trigger to SMF 120. Herein, the VLAN service authentication request trigger may include authentication device information.

Upon the completion of the subscription authentication procedure, SMF 120 may transmit a session create response (e.g., Nsmf PDU Session Create SMContext Response) to AMF 170 at step S204.

At step S205, SMF 120 transmits a VLAN service authentication request to AAA 130 (e.g., authentication device) according to the VLAN service authentication request trigger.

AAA 130 may operate as a secondary authentication node (e.g., DN authentication) of user equipments participating on VLAN. AAA 130 may perform VLAN authentication and/or VLAN IP address allocation based on DNN/IMSI/GPSI.

AAA 130 may extract user equipment ID from the VLAN service authentication request and perform VLAN service authentication which determines whether the extracted user equipment ID is included in the VLAN service information or not at step S206.

AAA 130 may determine user equipment 200 as a subscriber when the user equipment ID is included in the VLAN service information and allocate an IP address within a VLAN IP range matched with the user equipment ID at step S206.

AAA 130 may transmit a VLAN service authentication response including VLAN routing information including allocated IP address and user equipment ID to SMF 120 at step S207.

SMF 120 may select PCF 160, transmit a SM policy association establishment request to the second PCF 160, and receive a SM Policy Association Establishment Response at step S208.

SMF 120 may transmit N4 session establishment request including the acquired VLAN routing information, which is obtained at step S207, to UPF 110 and receive N4 session establishment response at step S210.

UPF 110 may generate a GTP tunnelling session for base station 180 and user equipment 200 at step S211. Here, GTP stands for GRPS tunneling protocol, and GRPS stands for general packet radio service.

UPF 110 may map the acquired VLAN routing information and the generated session ID (e.g., GTP ID) and update it at the VLAN routing information stored in memory (118 of FIG. 2) at step S212. The generated VLAN routing information may include user equipment ID, DNN, VLAN group ID, and an IP address matched with user equipment ID and GTP ID are updated.

SMF 120 may perform NAMF communication procedure by exchanging Namf_Communication_N1N2Message Transfer message with AMF 170 at step S213.

The session create procedure is completed by performing the PDU session establishment procedure at step S214.

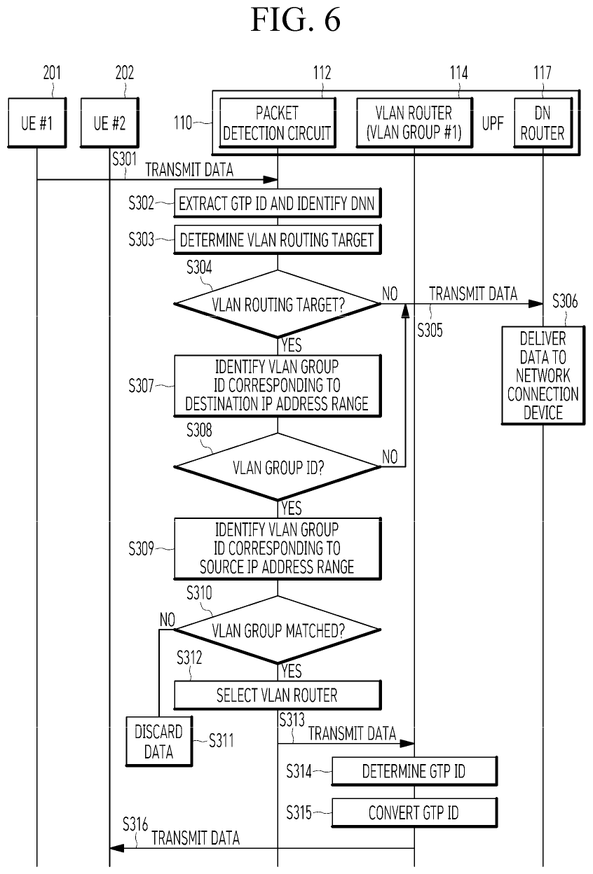

FIG. 6 is a flowchart illustrating a method for providing a VLAN service to user equipment in accordance with an embodiment.

Referring to FIG. 6, when user equipment #1 210 creates and transmits data to a predetermined destination, the transmitted data may be delivered to UPF 110 through radio access network 180. That is, UPF 110 may receive data from user equipment #1 210 at step S301.

UPF 110 (e.g., packet detection circuit 112) may extract a GTP ID from the received data and identify a data network name (DNN) corresponding to the extracted GTP ID from VLAN routing information stored in memory 118 (e.g., VLAN routing database) at step S302.

At step S303, UPF 110 may determine whether the received data is a target of VLAN routing based on the confirmed DNN. That is, UPF 110 checks if the VLAN group ID mapped to the confirmed DNN exists in the VLAN routing information stored in memory 118 (e.g., VLAN routing database).

At step S304, UPF 110 may determine that the received data is the target for VLAN routing if VLAN group ID mapped to DNN is included, and UPF 110 may determine that the received data is target for DN routing if VLAN group ID mapped to DNN is not included.

At step S305, UPF 110 may forward the received data to DN router 117 corresponding to DNN when the received data is target for DN routing.

At step S306, DN router 117 may transfer the data to network connection device 190 connected to a data network corresponding to DNN. Network connection device 190 may transfer the data to DN 301 because network connection device 190 is connected to DN 301.

At step S307, UPF 110 may identify a VLAN group ID corresponding to a range of a destination IP address extracted from the received data when the received data is the target for VLAN routing.

At step S308, UPF 110 may determine the received data as a target for DN routing if VLAN group ID is not identified and determine the received data as a target for VLAN routing if VLAN group ID is identified.

When it is determined as DN routing target (No—step S308), UPF 110 may transfer the data to DN router 117 corresponding to DNN at step S305.

When it is determined as VLAN routing target (Yes—step S308), UPF 110 may determine a VLAN group ID corresponding to a range of a source IP address at step S309.

UPF 110 may determine whether the destination VLAN group ID is matched with the source VLAN group ID at step S310.

When they are not matched (No—S310), UPF 110 may discard the received data at step S311. Basically, VLAN communication only allows to communicate within user equipments in the same VLAN group. Therefore, if VLAN group ID is different, data is transmitted from user equipment in another VLAN group. Therefore, the data is discarded.

When they are matched (Yes—S310), UPF 110 may select a VLAN router corresponding to the destination VLAN group ID among a plurality of VLAN routers at step S312. UPF 10 (e.g., packet detection circuit) may deliver the data to the selected VLAN router 114 at step S313.

VLAN router 114 may determine a GTP ID corresponding to the destination IP address of the received data from VLAN routing database at step S314. VLAN router 114 may convert the GTP ID of the receive data to the determined GTP ID at step S315. VLAN router 114 transmits the GTP ID converted data to user equipment #2 202 corresponding to the destination IP address at step S316.

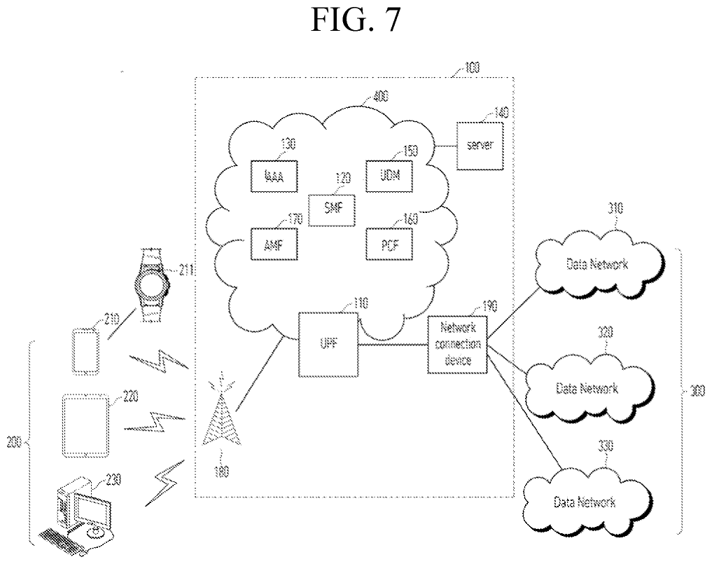

FIG. 7 is a diagram illustrating a VLAN service system in accordance with another embodiment. Referring to FIG. 7, VLAN service system may have a structure similar to that of FIG. 1. Therefore, the description of components identical to FIG. 1 is omitted, and only the components different from FIG. 1 are described.

User equipment 200 including primary devices 210, 220, and 230 are identical to those in FIG. 1. Further, they have structures identical to those described in FIG. 1 to FIG. 6. User equipment 200 including primary user equipments 210, 220, and 230 may be a 3GPP connectivity device. Primary user equipment 210 may be one connected to secondary user equipment 211.

Secondary user equipment 211 may be a non-3GPP connectivity device and be connected to core network 400 through primary user equipment 210. Secondary user equipment 211 may be connected to primary user equipment 210 and connected to core network 400 by primary user equipment 210. Such secondary user equipment 211 may be authenticated by authentication device (AAA) 130. That is, after authentication device 130 authenticates secondary user equipment 211 using predetermined method, secondary user equipment 200 may be able to access core network 400 through primary user equipment 210.

The method of authentication device (AAA) 130 for authenticating secondary user equipment 200 (e.g., non-3GPP user equipment) is predefined. Once the authentication device (AAA) 130 successfully authenticates secondary user equipment 200, authentication device 130 may assign an IP address from the VLAN IP range to secondary user equipment 200 and provides SMF 120 with necessary information for VLAN configuration, namely, the VLAN routing information, which includes the assigned IP address. SMF 120 relays the VLAN routing information received from authentication device 130 to UPF 110.

UPF 110 may process data transmitted from/to secondary user equipment 211 through primary user equipment 210 based on VLAN routing information. UPF 110 may use a GTP ID of primary user equipment 210 connected to secondary user equipment 211 to process data of secondary user equipment 211.

When primary user equipment 210 transmits or receive data of secondary user equipment 211, UPF 110 allocates data to VLAN router 114, 115, 116 based on a GTP ID of primary user equipment 210 and a VLAN group ID. VLAN router 114, 115, 116 may transfer data to a GTP tunnel mapped to a destination IP address.

Primary user equipment 210 may manage internal routing information for routing data of secondary user equipment 211 connected thereto. Therefore, primary user equipment 210 may process data even the destination IP address of the data is not an IP address of 3GPP user equipment.

UPF 110 segments data of user equipments (210, 220, 230) which are jointly using data networks 301, 302, 303, into VLAN groups. Typically, only one VLAN group could be allocated to one DNN. However, according to an embodiment, it is possible to form multiple VLAN groups segmented by VLAN group IDs within a single DNN, supporting inter-terminal D2D style VLAN communication.

As a result, not only can the limitations of the typical 5G LAN-type service be overcome, but by applying routing according to the same VLAN routing information to the data of secondary user equipment 211, a user equipment-based 5G VLAN service can be completed.

In this context, according to the embodiment in FIG. 7, the VLAN routing information described in Table 1 explained as in Table 4 to include secondary user equipment information.

TABLE 4

| | User | | VLAN group | | | Secondary UE | |
|---|---|---|---|---|---|---|---|
| VLAN | equip- | | data | | | Info | |
| group | ment | GTP | DNN/S- | GW | IP | Auth | UE |
| ID | ID | ID | NSSAI | IP | range | Info | IP |
| Key #1 | UE #1 | ID #1 | DNN #1 | Xxxx | Xxxxx/20 | | Xxx/20 |
| Key #1 | UE #2 | ID #2 | DNN #1 | xxxx | Xxxxx/20 | | Xxx/20 |

As shown, Table 4 includes information on secondary user equipment (e.g., secondary UE info). The information on secondary user equipment may include information on secondary user equipment 211 connected to primary user equipment 210, such as authentication information (Auth Info) and user equipment IP address (UE IP).

Authentication information may include information on a method of authenticating secondary user equipment 211, and user equipment IP address (UE IP) may include a VLAN IP range allocated to secondary user equipment 211.

According to embodiments shown in FIG. 7, subscription information may further include user equipment type to Table 2, like Table 5 below.

TABLE 5

| | | | | User |
|---|---|---|---|---|
| | GPSI | Virtual Group ID | | equipment |
| IMSI | (IMSISDN) | (External& Internal) | Type | IP |
| Key | Service | Virtual group service | Whether to | xxxx |
| | membership | Key | support 2^{nd} UE | |

In addition, according to the embodiment of FIG. 7, multi VLAN service management information may be augmented with secondary user equipment management information in Table 3, as shown in Table 6 below.

TABLE 6

| VLAN | | VLAN group data | | | Secondary UE Info | |
|---|---|---|---|---|---|---|
| group | | DNN, | Auth | IP | Auth | UE |
| ID | UE ID | S-NSSAI | Info | range | Info | IP |
| Key | Subscriber | Target | | Occupied | | Xxx/20 |
| | | NW | | IP | | |

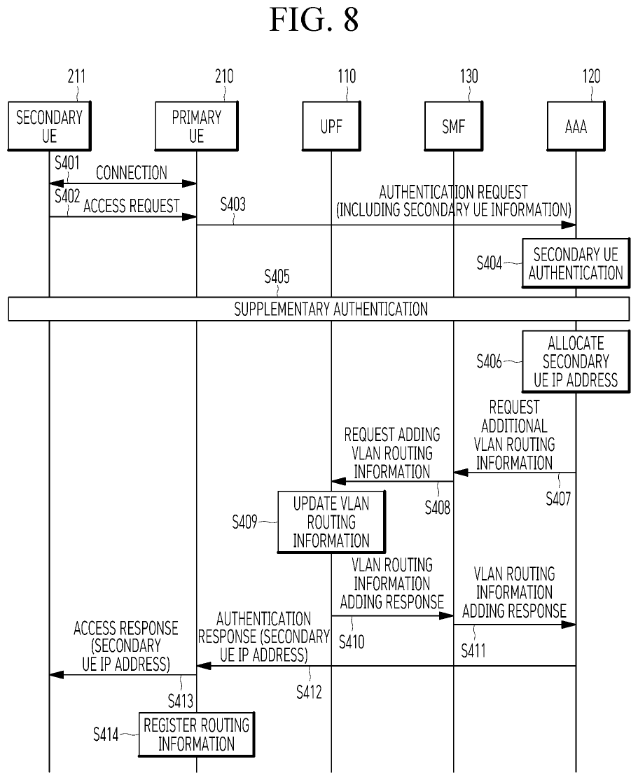

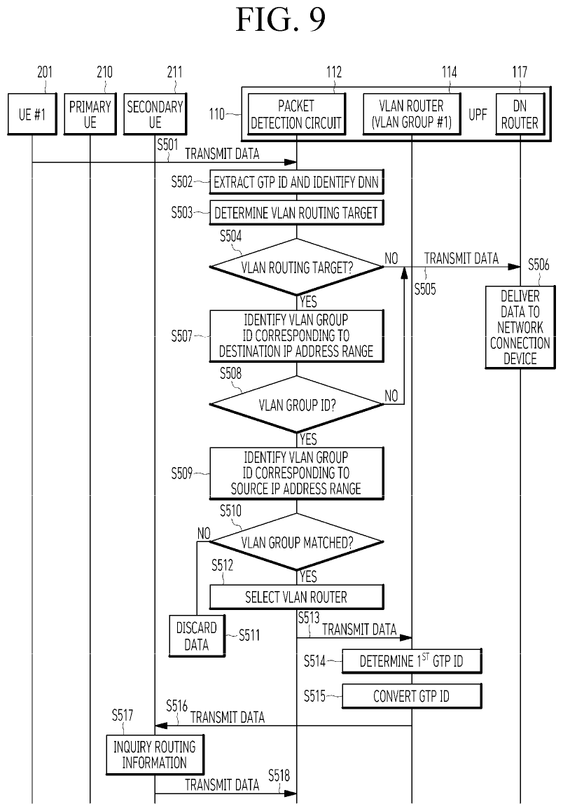

Hereinafter, a method for providing a VLAN service to secondary user equipment 211 connected to primary user equipment 210 in accordance with an embodiment will be described with reference to FIG. 8 and FIG. 9.

FIG. 8 is a flowchart illustrating a method for registering VLAN routing information of secondary user equipment connected to primary user equipment in accordance with an embodiment.

Referring to FIG. 8, primary user equipment 210 is connected to secondary user equipment 200 at step S401, secondary user equipment 200 requests access to primary user equipment 210 at step S402.

Primary user equipment 210 transmits information on primary user equipment and secondary user equipment to authentication device 130 at step S403. The primary user equipment information may be information for identifying primary user equipment 210 connected to secondary user equipment 211, for example, include DNN and UE ID (IMSI, GPSI). Secondary user equipment information may be information for authenticating VLAN access right of secondary user equipment 211, may include a media access control (MAC) address which is an identifier of secondary user equipment 211.

Authentication device (AAA) 130 may perform authentication that determine whether the received secondary user equipment information is registered in VLAN service information at step S404.

Authentication device 130 may perform supplementary authentication process (e.g., Extensible Authentication Protocol (EAP)) with primary user equipment 210 or secondary user equipment 211 according to VLAN service information at step S405.

Authentication device 130 may allocate an IP address of an IP range corresponding to a VLAN group identified as primary user equipment information after completing authentication of the secondary user equipment and supplementary authentication of second user equipment at step S406.

Authentication device 130 may transfer an addition request for VLAN routing information (e.g., VLAN routing information addition request) to SMF 120 at step S407.

The VLAN routing information addition request may include DNN of primary user equipment 210, user equipment identifiers (IMSI, GPSI), VLAN group identifier, and an IP address of secondary user equipment.

SMF 120 may transmit the VLAN routing information addition request to UPF 110 at step S408. UPF 110 acquires information on secondary user equipment in the VLAN routing information addition request and updates the VLAN routing information with the acquired information at step S409.

UPF 110 may transmit a VLAN routing information addition response to SMF 120 at step S410. SMF 120 may transmit VLAN routing information to authentication device 130 in response to the VLAN routing information addition response.

Authentication device 130 may transmit authentication response including allocated secondary user equipment IP address, second user equipment MAC address, and primary user equipment information to primary user equipment 210 at step S412.

At step S413, primary user equipment 210 transmits access response including the received secondary user equipment IP address to secondary user equipment 211.1

The operation at step S412 may be a session establishment procedure that assigns a secondary user equipment IP address between primary user equipment 210 and secondary user equipment 111. The session establishment procedure may include a step of transmitting the secondary user equipment IP address in the connection response for S402.

Primary user equipment 210 registers routing information mapped to the MAC address acquired in S402, the secondary user equipment IP address acquired in S412, and primary user equipment information (DNN/IMSI/GPSI) in S414. The registered routing information is used by primary user equipment 210 to rout the data of second user equipment 211. That is, based on the registered routing information, primary user equipment 210 routes data received from UPF 110 to secondary user equipment 211 and route data received from secondary user equipment 211 to UPF 110.

FIG. 9 is a flowchart illustrating a VLAN service procedure in accordance with another embodiment. The method in FIG. 9 is similar to the method in FIG. 6, with the difference being that the destination is secondary user equipment 211. Therefore, the contents similar to the method of FIG. 6 are briefly explained, and the focus is on explaining the components different from the method of FIG. 6.

Referring to FIG. 9, user equipment #1 201 may transmit data to UPF 110, and packet detection circuit 112 of UPF 110 receives the data at step S501. At step S502, packet detection circuit 112 extracts a GTP ID from the received data and confirms a DNN corresponding to the extracted GTP ID from a VLAN routing database (e.g., VLAN routing information).

At step S503, packet detection circuit 112 may determine whether the received data is a target for VLAN routing based on the confirmed DNN. At step S504, packet detection circuit 112 may determine that the received data is the target for VLAN routing if the VLAN group ID mapped to the DNN is registered at the VLAN routing database, and packet detection circuit 112 may determine that the received data is a target for DN routing if the VLAN group ID mapped to DNN is not registered at the VLAN routing database.

In the case of the DN routing target, packet detection circuit 112 may deliver the data to DN router 117 corresponding to the DNN at step S505. DN router 117 may transfer data to network connection device 190 connected to DN corresponding to DNN at step S506.

In the case of the VLAN routing target, packet detection circuit 112 may identify a VLAN group ID corresponding to an IP range of a destination IP address extracted from the data at step S507. If the VLAN group ID is not identified, packet detection unit 112 determines the data as DN routing target. Or if the VLAN group ID is identified, packet detection unit 112 determines the data as VLAN routing target at step S508.

If it is DN routing target, packet detection unit 112 may transmit the data to DN router 117 corresponding to DNN at step S505. If it is VLAN routing target, packet detection unit 112 determines a VLAN group ID corresponding to a range of a source IP address of the data at step S509.

Packet detection unit 112 may discard the received data at step S511 if the destination VLAN group ID is not matched with the source VLAN group ID.

Packet detection unit 112 selects a VLAN router corresponding to a destination VLAN group ID (e.g., VLAN group #1) among a plurality of VLAN routers at step S512 if the destination VLAN group ID is matched with the source VLAN group ID.

Packet detection unit 112 may transfer the data to the selected VLAN router 114 at step S513.

VLAN router 114 determines a GTP ID of primary user equipment 210 corresponding to the VLAN group identifier of the destination IP address from the VLAN routing database at step S514.

VLAN router 1114 converts the GTP ID of the received data to the determined GTP ID at step S515. VLAN router 114 transmits the data having the converted GTP ID to primary user equipment 210 corresponding to the GTP ID at step S516.

Primary user equipment 210 determines whether a destination IP address of the received data is registered at routing information at step S517. If the received data is registered at routing information, primary user equipment 210 transmits the data to secondary user equipment 211 at step S518.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present disclosure can be embodied in the form of methods and apparatuses for practicing those methods. The present disclosure can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present disclosure can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present disclosure can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

No claim element herein is to be construed under the provisions of 35 U.S.C. § 112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of an apparatus for providing a multi virtual local area network (VLAN) service to user equipment (UE), the method comprising:
storing VLAN routing information that includes user equipment information, which is information on user equipments subscribing to the multi VLAN service, and session information;
receiving data from a first user equipment and extracting user equipment information and session information from the received data;
determining whether the extracted user equipment information and session information is included in the VLAN routing information;
determining the received data as a VLAN routing target if the extracted user equipment information and session information is included in the VLAN routing information; and
transmitting the received data to a second user equipment corresponding to a destination of the received data based on the VLAN routing information.

2. The method of claim 1, wherein:
the VLAN routing information comprises i) session identifiers of sessions connected to a plurality of user equipments subscribing to the multi VLAN service and ii) Internet Protocol (IP) addresses allocated to the plurality of user equipments, each mapped to the session identifiers;
the transmitting comprises: determining a session identifier matched with a destination IP address of the received data from the VLAN routing information; converting a session identifier of the received data to the determined session identifier; and transmitting the received data with the converted session identifier to a second user equipment corresponding to the destination IP address; and
the session identifier matched the destination IP address is a session identifier of a session connected to the second user equipment.

3. The method of claim 2, wherein:
the VLAN routing information includes session identifiers, IP address ranges, network identifiers, and VLAN group identifiers of user equipments subscribing to the multi VLAN service;
the determining the received data as a VLAN routing target comprises i) determining whether a network identifier matched to a session identifier extracted from the received data is included in the VLAN routing information, ii) determining whether a destination IP address extracted from the received data is included in the VLAN routing information in an event that the network identifier is included in the VLAN routing information, iii) determining the received data as a VLAN routing target in an event that the destination IP address is included in the VLAN routing information.

4. The method of claim 3, wherein:
the VLAN routing information includes the session identifier, the IP address range, and the network identifier, which are matched with a plurality of VLAN group identifiers;
prior to the determining the received data as a VLAN routing target, the method comprise: determining whether a VLAN group identifier matched to an IP range including the destination IP address is identical to a VLAN group identifier matched to an IP range including a source IP address extracted from the received data; and
the determining comprises: determining the received data as a VLAN routing target in an event that the VLAN group identifiers are identical.

5. The method of claim 4, further comprising:
discarding the received data the VLAN group identifiers are not identical after the determining.

6. The method of claim 1, wherein, after the storing, further comprising:
delivering the received data to a data network in an event that the destination IP address determined from the received data is not registered at the VLAN routing information.

7. The method of claim 1, wherein:
prior the storing, further comprising: receiving a session establishment request for the plurality of user equipments from a session management function (SMF); and
the VLAN routing information is obtained from the session establishment request.

8. The method of claim 1, wherein:
after the storing, further comprising: receiving VLAN routing addition information from a session management function (SMF), wherein the VLAN routing addition information includes information on a secondary user equipment connected to a primary user equipment, wherein the primary user equipment is a user equipment directly connected to a session, and the secondary user equipment is a user equipment connected to a session through the primary user equipment; and mapping the VLAN routing addition information to a session identifier of the primary user equipment connected to the secondary user equipment and storing the mapped VLAN routing addition information;
the second user equipment is the primary user equipment which is identified based on a session identifier matched to a destination IP address extracted from the received data; and
the received data is routed to the secondary user equipment by the primary user equipment.

9. The method of claim 8, wherein the VLAN routing information includes i) general packet radio service tunnelling protocol (GTP) ID as the session identifier, data network name (DNN) as a network identifier, a VLAN group identifier, a user equipment identifier of a user equipment connected to a session, a IP address range allocated to the user equipment connected to the session, and an IP address range allocated to the secondary user equipment which is a lower level user equipment of the user equipment connected to the session.

10. A method of an authentication apparatus for providing a multi virtual local area network (VLAN) to user equipment, the method comprising:
receiving a VLAN service authentication request of a target user equipment for creating a session from a session management function (SMF); and
transmitting a VLAN service authentication response including information on an Internet Protocol (IP) address allocated to the user equipment to the SMF,
wherein the allocated IP address is transferred to a user plane function (UPF) by the SMF and used to perform VLAN communication between user equipments by the UPF.

11. The method of claim 10, wherein:
the target user equipment is a primary user equipment that is connected to a secondary user equipment and supports network access of the secondary user equipment;
after the transmitting, the method comprising: receiving a VLAN service authentication request of the secondary user equipment from the primary user equipment;
determining whether the secondary user equipment subscribes for the multi VLAN service based on secondary user equipment information identified from the VLAN service authentication request;
allocating an IP address within an IP range matched to a VLAN group identifier determined based on an network identifier extracted from the VLAN service authentication request or the secondary user equipment information in an event that the secondary user equipment subscribes to the multi VLAN service; and
transmitting a VLAN service authentication response including the allocated IP address to the primary user equipment.

12. The method of claim 11, wherein
after the allocating, the method further comprising: transmitting the IP address allocated to the secondary user equipment to the SMF;
the IP address allocated to the secondary user equipment is transmitted to the UPF from the SMF and used for the VLAN communication.

13. An apparatus connected to internal nodes of a core network and performing operations as a user plane function (UPF) for providing a multi virtual local area network (VLAN) to user equipment, the apparatus comprising:
a memory configured to store VLAN routing information including user equipment information and session information of user equipments subscribing the multi VLAN service; and
at least one processor configured to create at least one VLAN router per each VLAN group for relaying communication between user equipments belonging to a same VLAN group through the created at least one VLAN router,
wherein the at least one VLAN router determines that the received data is a VLAN routing target in an event that user equipment information and session information extracted from a first user equipment is included in the VLAN routing information and transmitting the received data to a second user equipment which is a destination of the received data based on the VLAN routing information.

14. The apparatus of claim 13, wherein:
the VLAN routing information includes mapping information of session identifiers of sessions connected to a plurality of user equipments subscribing the VLAN service and IP addresses allocated to the plurality of user equipments; and
the at least one VLAN router is configured to convert the session identifier of the received data to a session identifier matched to a destination IP address of the received data in order to transmit the received data to the second user equipment corresponding to the destination IP address.

15. The apparatus of claim 14, wherein further comprising:
a packet detection circuit configured to analyze the received data based on a packet detection rule (PDR) and relay the received data to the at least one VLAN router based on a forwarding detection rule based on the analysis result.

16. The apparatus of claim 15, wherein:
the VLAN routing information comprises mapping information on session identifiers, IP address ranges, network identifiers, and VLAN group identifiers of user equipments subscribing the multi VLAN service;
the packet detection circuit is configured to:
extract a session identifier, a destination IP address, and a source IP address from the received data according to the packet detection rule,
determine a network identifier matched to the session identifier from the VLAN routing information, and
relay the received data to a VLAN router corresponding to the VLAN group identifier according to the forwarding detection rule.

17. The apparatus of claim 16, wherein the packet detection circuit is configured to:
determine whether a VLAN group identifier matched to the source IP address of the received data is identical to a VLAN group identifier matched to the destination IP address of the received data based on the VLAN routing information;
delivering the received data to the VLAN router in an event that the VLAN group identifiers are identical; and
discarding the received data in an event that the VLAN group identifiers are not identical.

18. The apparatus of claim 15, further comprising:
a tunneling interface configured to be connected to tunneling sessions of the plurality of user equipments and to be connected to the at least one router.

19. The apparatus of claim 18, further comprising:
a data network router configured to route the received data to a corresponding data network,
wherein the packet detection circuit is configured to transmit the received data to the data network router in an event that the determined session identifier or the destination IP address is not registered at the VLAN routing information.

20. The apparatus of claim 19, wherein:
the IP address range includes a primary user equipment IP address range of IP addresses allocated to a primary user equipment, a secondary user equipment IP address range of IP addresses allocated to at least one secondary user equipment wherein the primary user equipment is a user equipment directly connected to the sessions, and the secondary user equipment is a user equipment connected to the sessions through the primary user equipment;
the VLAN routing information includes mapping information of the primary user equipment IP address range and the secondary user equipment IP address range; and
the at least one VLAN router is configured to: determine the primary user equipment IP address range from the VLAN routing information using the destination IP address; convert a session identifier of the determined primary user equipment IP address range with a session identifier of the received data, and delver the received data to a primary user equipment connected to a secondary user equipment corresponding to the destination IP address.
